(19) United States
(12) Patent Application Publication
(10) Pub. No.: US 2023/0085068 A1
(43) Pub. Date: Mar. 16, 2023

(54) GONDOLA MONITORING SYSTEMS AND RELATED METHODS

(71) Applicant: G3 Enterprises, Inc., Modesto, CA (US)

(72) Inventors: John Cunningham, Tracy, CA (US); Miriam Torrison, Modesto, CA (US); Rebekah Wong, Modesto, CA (US)

(21) Appl. No.: 17/869,199

(22) Filed: Jul. 20, 2022

Related U.S. Application Data
(63) Continuation-in-part of application No. 17/473,213, filed on Sep. 13, 2021.

(51) Int. Cl. A01D 90/12; A01D 90/10

(52) U.S. Cl. CPC A01D 90/12; A01D 90/10; B60P 1/04

(57) ABSTRACT

Described herein are sensor systems and methods for monitoring conditions of a gondola configured to hold harvested produce and be transported by a trailer. The sensor system can include a capacity sensor configured to determine a remaining capacity of the gondola. The sensor system can include a temperature sensor configured to monitor a temperature of the gondola, harvested produce, and/or an environment around the gondola. The sensor system can include a trailer location sensor configured to determine a global position of the gondola. A communication module in communication with the capacity sensor, the temperature sensor, and the trailer location sensor can transmit data from the capacity sensor, the temperature sensor, and the trailer location sensor to a remote computing system.

### CROSS-REFERENCE TO RELATED APPLICATIONS

This application is a continuation-in-part of and claims priority to U.S. patent application Ser. No. 17/473,213, filed on Sep. 13, 2021, the entire disclosure of which is incorporated by reference.

### FIELD

The present disclosure relates to systems and methods for monitoring conditions of a gondola and, in particular, systems and methods for monitoring gondolas configured to hold harvested bulk produce that is transported on a trailer from fields to off-site storage and/or processing facilities.

### BACKGROUND

During the harvest of a given crop (e.g., fruits, vegetables, nuts, etc.), produce may be picked from the field (e.g., mechanically or by hand) and loaded into gondolas. Gondolas, which can be open-top vessels, are configured to receive and contain bulk quantities of produce and are typically attached to and transported on a trailer from fields to off-site processing facilities. The size and geometry (e.g., high opaque walls) of a typical gondola can obscure visual monitoring by field personnel or equipment operators of gondola contents during filling. This is further exacerbated in cases where multiple gondolas are attached to a common trailer for transportation. Because a field worker or loader operator is generally not able to directly determine a level and distribution of produce in the gondola, the gondola may be filled improperly and/or weight imbalances can occur within or among the gondolas. Inaccessibility of the gondolas can also make monitoring other conditions of the gondolas and the produce contained therein difficult.

The foregoing discussion, including the description of motivations for some embodiments of the invention, is intended to assist the reader in understanding the present disclosure, is not admitted to be prior art, and does not in any way limit the scope of any of the claims.

### SUMMARY

Described herein are sensor systems for monitoring conditions of a gondola (or other container or vessel) in which the gondola is configured to hold harvested produce (e.g., in bulk) and be transported on a trailer to a storage or processing facility. An example sensor system can include one or more capacity sensors configured to determine if the gondola contains produce and/or an available or remaining capacity of the gondola (e.g., a volume of additional or remaining storage available in the gondola). The example sensor system can include one or more temperature sensors configured to monitor a temperature of the gondola, a temperature of an environment in or around the gondola, and/or a temperature of harvested produce in the gondola. The example sensor system can include a tilt sensor configured to monitor a tilt of the gondola and a trailer location sensor configured to determine a global position of the gondola. The example sensor system includes a communication module in communication with the capacity sensor, the temperature sensor, the tilt sensor, and/or the trailer location sensor and can be configured to transmit data from these sensors to a remote data storage and/or remote computing system.

Also described herein are methods for monitoring conditions of a gondola (or other container or vessel), in which the gondola is configured to hold harvested produce and be subsequently transported on a trailer to a storage or processing facility. An example method can include obtaining, via one or more capacity sensors, capacity data indicating a remaining capacity of the gondola (e.g., a remaining volume available for storage) and/or an amount of produce in the gondola. The method can include obtaining, via one or more temperature sensors, temperature data indicating a temperature of the gondola, a temperature of an environment in or around the gondola, and/or a temperature of the harvested produce in the gondola. The method can include obtaining, via a tilt sensor, tilt data indicating whether the gondola is tilting and obtaining, via a trailer location sensor, trailer location data indicating a global position of the gondola. The example method can include transmitting, via a communication module, the capacity data, the temperature data, the tilt data, and the trailer location data to a remote data storage and/or remote computing system. The communication module is in communication with the capacity sensor, the temperature sensor, the tilt sensor, and the trailer location sensor (e.g., by wired or wireless communications).

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of any of the present inventions. As can be appreciated from foregoing and following description, each and every feature described herein, and each and every combination of two or more such features, is included within the scope of the present disclosure provided that the features included in such a combination are not mutually inconsistent. In addition, any feature or combination of features may be specifically excluded from any embodiment of any of the present inventions.

The foregoing Summary, including the description of some embodiments, motivations therefor, and/or advantages thereof, is intended to assist the reader in understanding the present disclosure, and does not in any way limit the scope of any of the claims.

### BRIEF DESCRIPTION OF THE DRAWINGS

The accompanying figures, which are included as part of the present specification, illustrate the presently preferred embodiments and together with the general description given above and the detailed description of the preferred embodiments given below serve to explain and teach the principles described herein.

FIG. 1 is a schematic diagram of an example set of gondolas mounted on trailers configured for carrying harvested produce.

FIG. 2 is a schematic diagram of an example sensor system configured to monitor one or more gondolas.

FIG. 3 is an image of a perspective view of an example sensor system attached to the side of a gondola.

FIG. 4 is an image of a top view of an example sensor system for monitoring gondolas.

FIGS. 5A-5B are schematic diagrams of an example sensor system for monitoring gondolas.

FIG. 6 is a schematic diagram of an example communication scheme for monitoring gondolas.

FIG. 7 is a schematic diagram of an example sensor system for monitoring gondolas.

FIG. 8 is a schematic diagram of an example communication scheme for monitoring gondolas.

FIG. 9 is a schematic diagram of an example communication scheme for monitoring gondolas.

FIG. 10 is a schematic diagram of an example communication scheme for monitoring gondolas.

FIG. 11 is a schematic diagram of an example communication scheme for monitoring gondolas.

FIG. 12 is a schematic diagram of an exemplary hardware and software systems implementing the systems and methods described herein.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

In certain examples, “capacity” can refer to a volume for storing or carrying produce or other items in a gondola or other container. For example, a “current capacity,” “fill capacity,” “fill level capacity,” or “fill level” can refer to a current volume of produce held in the gondola. Likewise, in certain examples, “remaining capacity” or “available capacity” can refer to an additional volume available for storing or carrying produce or other items in the gondola or other container. For example, an empty gondola can have a remaining capacity that is equal to its entire capacity (e.g., an entire storage volume), while a gondola that is half full can have a remaining capacity that is equal to half of its entire capacity.

Systems and methods for monitoring conditions of gondolas are disclosed. In particular, the example systems and methods can be used to monitor gondolas used to hold bulk harvested produce. The gondolas may be monitored for capacity, temperature, tilt, geographic location, etc. Such monitoring may have one or more benefits. For example, by tracking the trailer location (e.g., global position) of the gondolas, the systems can be configured to ensure on-time delivery of produce by the gondolas to a destination. In another example, the systems can ensure that field workers or equipment operators (e.g., harvesters or loaders) are able to fill gondolas to capacity and have an adequate supply of gondolas, thereby saving valuable time in the field. Otherwise, field operations may be interrupted while additional gondolas are delivered from a different location. In another example, the monitoring of gondolas may be used to prevent injuries in the field due to field workers climbing gondolas to check the contents held therein. In another example, by dispatching gondolas to processors as soon as they are at maximum fill level capacity, the time that a gondola sits full near a vineyard or other field can be minimized, thereby preventing product damage and adverse quality impact due to excessive or unnecessary storage time prior to processing.

In another example, gondola and/or trailer utilization can be increased or maximized, thereby reducing costs for relocating empty trailers (especially during peak season). In yet another example, the gathering of gondola related data, including fill level capacity (e.g., during peak season) can reduce future capital purchases needed to meet harvest volume demands. In another example, the system can collect data to help determine how and/or where to allocate and/or position gondolas (e.g., across the state, within a region, etc.). In another example, some sensor data (e.g., temperature) may be used to monitor conditions that can impact produce quality. Monitoring gondola conditions on-site and in real-time can reduce and/or eliminate later testing in an off-site quality control laboratory (e.g., winery lab). As illustrated, GPS data (e.g., including date, time stamp, coordinates, etc.) used in combination with other sensor technologies can improve harvesting efficiencies and reduce cost.

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details.

Measurements, sizes, amounts, etc. may be presented herein in a range format. The description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as 10-20 inches should be considered to have specifically disclosed subranges such as 10-11 inches, 10-12 inches, 10-13 inches, 10-14 inches, 11-12 inches, 11-13 inches, etc.

### Monitoring Gondolas

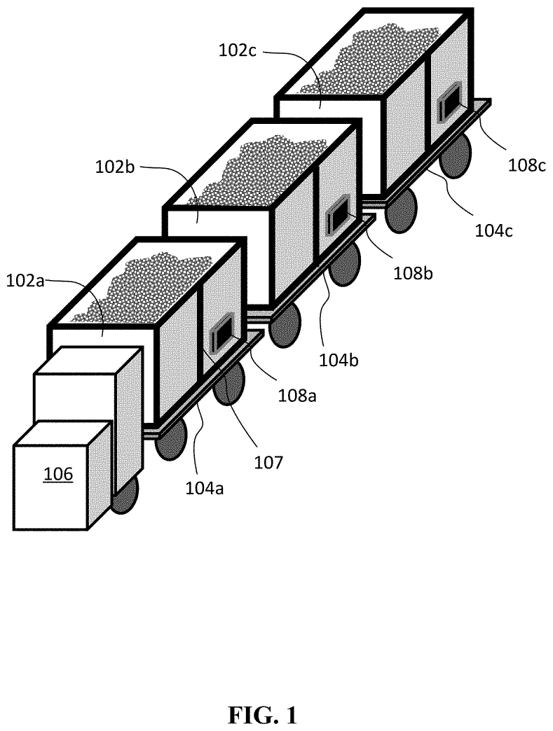

In general, gondolas are containers configured to hold bulk harvested produce and are typically transported on a trailer. The trailer may be hitched to a tractor or other truck power unit for movement among an open field or movement to and/or from a field (e.g., to an off-site storage warehouse or processor). Gondolas may be of varying shapes, sizes, capacities, weights, etc. The gondolas may be open, partially open, or closed on top. Gondolas may be made of various materials, e.g., a fiberglass container with a metal frame. FIG. 1 illustrates serially connected gondolas 102a, 102b, 102c (collectively referred to as 102) carried on respective trailers 104a, 104b, 104c (collectively referred to as 104). Note that, in some cases, two or more gondolas 102 may share a trailer 104. The trailers 104 are hitched to a tractor or other truck power unit 106 for transportation. As illustrated, each gondola 102 may include, be supported by, or be contained within a metal frame 107.

As described, after field harvesting, a portion of the produce (e.g., grapes) can be loaded into one of the gondolas (e.g., 102a). However, due to its size and opacity, it is generally not convenient or easy for a field worker or loader operator to determine which gondola was filled last or a current fill level of produce in a given gondola. An example gondola 102 and frame 107 may be 56 inches tall, 96 inches wide, and 139 inches in length. Trailer tire diameter may range from 16 to 22 inches. Therefore, for example, the top-side opening of a gondola 102 may be six feet or more off the ground, making it difficult for the average person to look into. Therefore, a field worker may be forced to remember which gondola was filled last and/or climb up onto the trailer to see the contents of the gondola. Because most or all of the gondolas are similar in shape, size, and/or color, it is not simple to remember which gondola was filled last. Further, substantial time (e.g., several hours) may pass between instances when the gondolas were filled, which can make the task of remembering which one was filled last even more difficult. Additionally, it can be beneficial to balance the load in gondolas that are installed on one trailer. This can be important for transporting the gondolas efficiently and safely.

In various embodiments, each gondola may be monitored by a sensor system. In some embodiments, gondolas 102a, 102b, 102c have their own respective sensor systems 108a, 108b, 108c (collectively referred to as 108). In some embodiments, two or more gondolas 102 share a sensor system 108. As described further below, the sensor system 108 can be configured to monitor capacity (e.g., an available or remaining capacity), temperature, tilt, and/or trailer location associated with the gondolas 102a, 102b, 102c. In some embodiments, the sensor system 108 is positioned on the gondola so as to avoid drilling through the walls of the gondola or to avoid any component of the sensor system falling into the gondola. These undesirable attachment techniques may compromise the integrity of the gondola and/or the produce held inside. Further, it is beneficial for the sensor system 108 to be secured onto the gondola 102 to prevent any component of the sensor system 108 from falling during transit, thereby damaging the system 108 and/or causing harm to the gondola 102 or trailer 104 that runs over the system 108. In some embodiments, the sensor system 108 may be attached to the gondola 102 by adhesive. In some embodiments, the sensor system 108 may be attached to the metal frame 107 by mechanical fastener (e.g., zip tie, etc.).

Although the following description may focus on applications pertaining to produce (e.g., vegetables, fruit, nuts, etc.), the example systems and methods may be used for monitoring other containers or cargo. It is understood that the example systems and methods described herein may be used for or configured for other produce containers, shipping containers, cargo containers, trailers, etc. The example systems and methods may be used for agricultural purposes, non-agricultural purposes (e.g., for hauling dirt, gravel, sand, concrete, etc.), retail purposes, warehousing, etc.

Sensor Systems and Methods

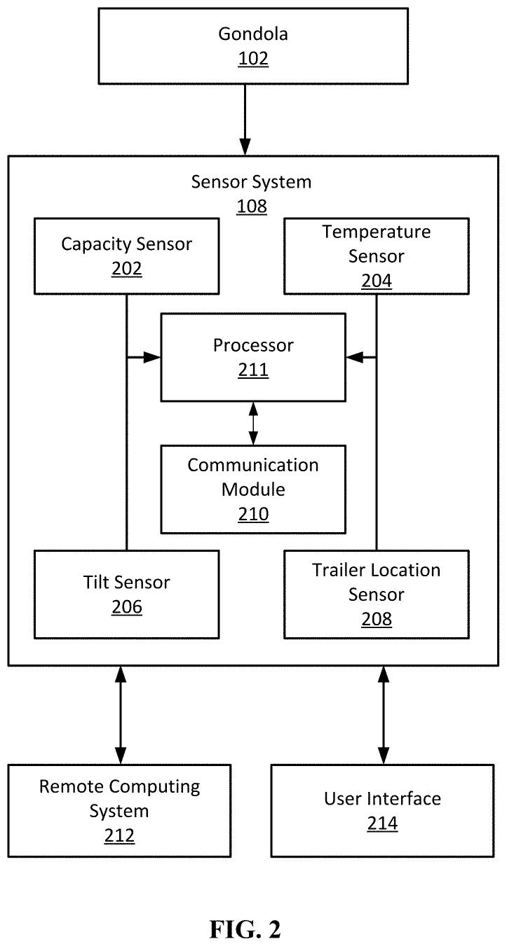

FIG. 2 illustrates an example sensor system 108 for monitoring a gondola 102. The example sensor system 108 may include one or more capacity sensors 202 (e.g., to measure load presence, capacity of load, an amount of produce in the gondola 102, or a remaining capacity of the gondola 102), one or more temperature sensors 204, one or more tilt sensors 206, one or more trailer location sensors 208, and one or more communication modules 210. The sensors 202, 204, 206, 208 and communication module 210 can be coupled to a processor 211 (alternatively referred to herein as a processing module). In some embodiments, the processor 211 and communication module 210 are co-packaged or separately packaged. In some embodiments, the processor 211 and/or the communication module 210 are co-packaged with or separately packaged from the sensor system 108. The components of the sensor system 108 may be packaged in one or more housings. The housings may include various materials, e.g., plastic, metal, etc. For example, the housing may be a ruggedized plastic with metallic mounts. The housing may be water-resistant or water-proof.

The one or more capacity sensors 202 can be used to determine the available or remaining capacity of the gondola 102. Alternatively or additionally, the capacity sensors 202 can be used to determine a current capacity or fill level capacity of the gondola 102 (e.g., an amount of produce in the gondola 102). In some embodiments, the capacity sensors 202 can be or include a capacitive sensor mounted in or on a wall or floor of the gondola 102. The capacitive sensor can utilize capacitive sensing or capacitive coupling to detect or measure a presence of produce near the sensor. In one example, the capacitive sensor can be mounted in or near a hole or window of the gondola 102 and can be used to determine if the gondola 102 contains any produce near the hole or window. Multiple capacitive sensors can be installed in or around the gondola 102. For example, a side wall of the gondola 102 can have capacitive sensors installed at a variety of heights above the floor of the gondola 102 (e.g., separated by intervals of about 3, 6, or 12 inches). Signals from the capacitive sensors can be used to determine a height or fill level of the produce in the gondola 102. For example, the height can be determined by identifying the capacitive sensor that is highest above the floor and detecting the presence of produce. Additionally or alternatively, the one or more capacity sensors 202 can be or include a load cell or force-sensing resistor to measure produce quantities or capacities on an analog scale. For example, the capacity sensors 202 can be or include a force sensing resistor (FSR) sensor (e.g., FlexiForce A401 made by TEKSCAN, Inc. of South Boston, Mass., USA). The example resistor may have a sensing area of approximately 1 in (25 mm) diameter or more. The resistor can be installed (e.g., mounted, fastened, etc.) between the gondola 102 and metal frame 107. As the gondola 102 fills, increasing force is applied to the FSR, decreasing the electrical resistance in the sensor which is proportional to the force applied. The change in resistance can be used to determine the fill level (e.g., when density of fill material is known), weight, and/or remaining capacity of the respective gondola 102. Additionally or alternatively, in some examples, the capacity sensors 202 can be or include one or more sensors that directly sense gondola contents through the use of optical, laser, or similar techniques (e.g., a camera). Such sensors can peer through a hole or window in a wall of the gondola, and/or can view the contents over a top edge of the gondola 102, to determine an amount of produce inside the gondola 102.

The temperature sensor 204 can be used to determine a temperature of an environment in or around the gondola 102 and/or a temperature of the contents (e.g., the produce) of the gondola 102. For example, a temperature sensor 204 may be configured to determine the temperature outside of the gondola 102 (e.g., an air temperature). Based on the determined outside temperature, the processor 211 can determine (e.g., derive) the temperature of the product inside the gondola 102 (e.g., using one or more predictive/analytic models). In some embodiments, the temperature sensor 204 can be or include a probe (e.g., an infrared thermometer) inside the gondola 102, or peering through a hole, window, or over a top edge of the gondola 102, for monitoring the temperature inside the gondola 102 (e.g., of the produce).

In some embodiments, the tilt sensor 206 can be configured to determine a tilt angle of the gondola 102. The tilt sensor 206 can be beneficial to indicate when the gondola 102 is being emptied (e.g., by tilting the gondola 102 to empty its contents). Additionally or alternatively, this tilt information combined with the capacity sensor data can be used to automatically determine if the gondola contents have been transferred to the customer and/or to automatically produce an invoice with no human intervention. In some embodiments, the tilt sensor can determine whether and/or the degree to which the gondola 102 is tipping relative to the trailer 104 or the ground (e.g., not level or tilting to a side, front, or back). In some embodiments, the tilt sensor 206 includes an accelerometer, a force balance sensor, a microelectromechanical system (MEMS), a capacitive tilt sensor, and/or an electrolytic sensor. For example, the tilt sensor 206 can be or include a 3-axis accelerometer configured to sense movement and/or tilt in the x-, y-, and z-axes.

The trailer location sensor 208 (alternatively referred to herein as a GPS sensor or a GPS tracking device) can be configured to determine the geographic location of the gondola 102. For example, the trailer location sensor 208 can be configured to receive global position data from a satellite and/or a cellular phone tower.

Additionally or alternatively, in some examples, the sensor system 108 can include one or more other sensors to monitor other parameters associated with the gondola 102 or contents of the gondola 102. For example, the sensor system 108 can include a light sensor for monitoring exposure to sunlight. The light sensor can be used to determine, for example, a length of time (e.g., in minutes or hours) that produce in the gondola 102 has been exposed to direct sunlight. In some examples, the sensor system 108 can include a humidity sensor to measure humidity in or around the gondola 102 and/or a water sensor to detect moisture in the gondola 102 (e.g., due to rain).

In various implementations, the sensor system 108 can be used to monitor the quality of produce (e.g., grapes) in the gondola 102. For example, the temperature sensor 204, the light sensor, the humidity sensor, the water sensor, the capacity sensor 202, the tilt sensor 206, the trailer location sensor 208, a camera, an optical sensor (e.g., optical gas sensor such as an infrared laser-based gas sensor), a spectroscopy device (e.g., a laser photoacoustic spectroscopy device), a dielectric property sensor, a biosensor, and/or a chemical sensor can be used to monitor produce conditions over time and provide notifications or alerts to system operators when produce conditions or quality have deteriorated or are at risk of deteriorating. Such alerts can be generated, for example, when measurement data from the sensor system 108 indicates that conditions in or around the produce are or have been excessive. Excessive conditions can be determined based on one or more of the following: a temperature in or around the produce has been above or below a threshold value for a specified amount of time; the produce has been exposed to direct sunlight for more than a threshold amount of time; the produce has been exposed to high or low moisture levels for more than a threshold amount of time; a color of the produce has changed over time; the produce has been in the gondola for an excessive period of time; and/or a sensor detects the presence of fermentation in the produce. In response to the generated alerts, the system operators (e.g., gondola drivers) can take corrective action, such as moving the gondola 102 to a different location where the produce can be processed and/or where environmental conditions are less extreme.

The communication module 210 can be in communication with and receive data from the capacity sensor 202, temperature sensor 204, tilt sensor 206, and/or trailer location sensor 208. For example, the communication module 210 may receive data wirelessly or by wire from the sensors 202, 204, 206, and/or 208. The communication module 210 may transmit data from one or more of sensors 202, 204, 206, or 208 to a remote computing system 212. In some embodiments, the sensor system 108 may include or be coupled to a user interface 214 that accepts user input and/or displays information (e.g., sensor data).

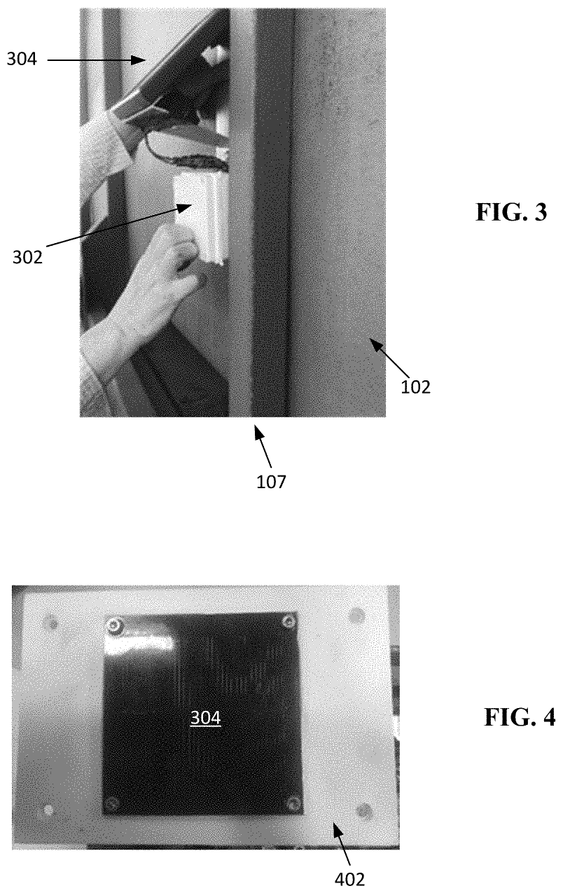

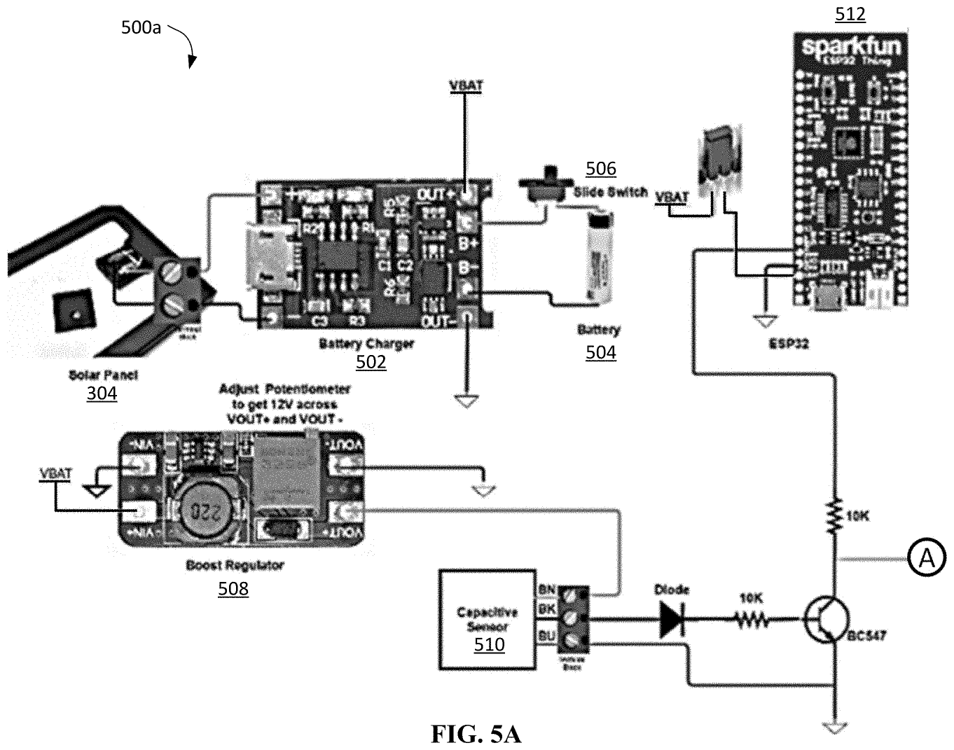

The sensor system 108 can derive power from a power source, e.g., a battery. In some embodiments, the battery may be coupled to a solar panel for charging purposes. FIG. 3 illustrates an example sensor system 108 in housing 302. The system 108 is connected to a solar panel 304, which is attached to an exterior side or wall of the gondola 102. In some cases, the solar panel 304 is attached to the housing 302 of the sensor system 108, as illustrated in FIG. 4 (in which the solar panel 304 obscures the housing 302 of the sensor system 108). The wiring of the solar panel 304 is directed through the lid of the housing 302 and is connected to the battery inside the housing 302. FIG. 4 also illustrates a fixture 402 (e.g., plate) for mounting the sensor system 108 and solar panel to the side of the gondola 102. For example, the fixture 402 can be mounted to the gondola 102 via screws, adhesive, ties, etc. In some cases, the solar panel 304 may be attached to the metal frame 107. In some implementations, the sensor system 108 and/or the battery can receive power from a truck, tractor, or other vehicle connected to the gondola 102. For example, in addition to or instead of receiving power from the solar panel 304, the sensor system 108 can receive power from a battery on the vehicle.

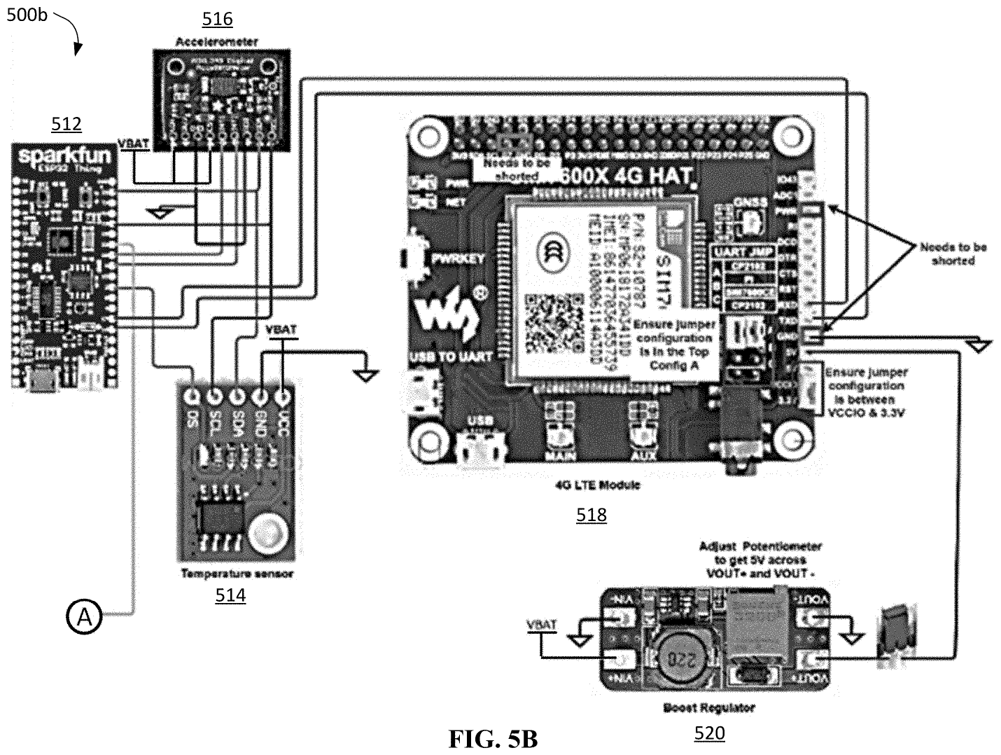

FIGS. 5A-5B show schematics 500a, 500b (collectively referred to as schematic 500) of the sensor system 108. Schematic 500a includes a solar panel 304 (e.g., 0.5 W 5V 100 mA Mini Small Solar Panel Module made by SUNNYTECH of San Jose, Calif., USA) electrically connected to a battery charger 502 (e.g., made by HILETGO TECHNOLOGY, Co., Ltd. of Shenzen, China) and battery 504 (e.g., a Lithium battery in a battery holder, e.g., Battery Holder 18650 made by HILETGO TECHNOLOGY, Co., Ltd.). The power to the sensor system 108 can be controlled by a user via slide or button switch 506. The battery 504 can power a boost regulator 508 (e.g., MT3608 DC-DC Boost Converter 2A made by XI'AN AEROSEMI TECHNOLOGY Co., Ltd. of Xi'an, China), which can include a potentiometer to adjust the voltage at its output. The boost regulator 508 can be connected to one or more capacity sensors, such as a capacitive sensor 510 (e.g., BCSS00TP Capacitive Level Sensor made by BALLUFF Inc. of Florence, Kent., USA) configured for fill level detection of produce through the side wall of the gondola 102. In some examples, the capacitive sensor 510 (alternatively referred to as a capacity sensor) is able to detect the fullness and/or current capacity of the gondola without contacting the interior of the gondola 102.

Referring still to FIG. 5A, the output of the capacitive sensor 510 is connected to the input of a communication module 512. This communication module 512 (e.g., HiLetgo ESP-WROOM-32 ESP32 ESP-32S Development Board 2.4 GHz made by HILETGO TECHNOLOGY, Co., Ltd. or SparkFun ESP32 Thing Development Board made by SPARKFUN ELECTRONICS of Niwot, Colorado, USA) can include a Wi-Fi module (configured to receive and/or transmit data over a Wi-Fi connection) and/or a Bluetooth module (configured to receive and/or transmit data over a Bluetooth connection).

Referring now to FIG. 5B, the same communication module 512 is connected to a temperature sensor 514 (e.g., COMIMARK LM75A Temperature Sensor High Speed I2C Interface Development Board Module) and accelerometer 516 (e.g., Digital Accelerometer ADXL345 Module made by SUNFOUNDER of Shenzen, China). The communication module 512 is connected further to a communication module 518 (e.g., 4G LTE module made by WAVESHARE ELECTRONICS of Shenzen, China) which includes a global positioning system (GPS). The communication module 518 is connected to a boost regulator 520. The communication module 518 can be configured to transmit the sensor data from the capacitive sensor 510 (or other capacity sensing systems), temperature sensor 514 and accelerometer 516 via cellular connection to a remote computing system (e.g., system 212, server system, cloud, etc.). The communication module 518 may also transmit GPS data associated with the sensor system 108. In some embodiments, the remote computing system 212 may retrieve the sensor data and/or GPS data from the communication module 518. The communication module 512 and/or the communication module 518 can be included in the communication module 210 described herein.

### Sensor Data

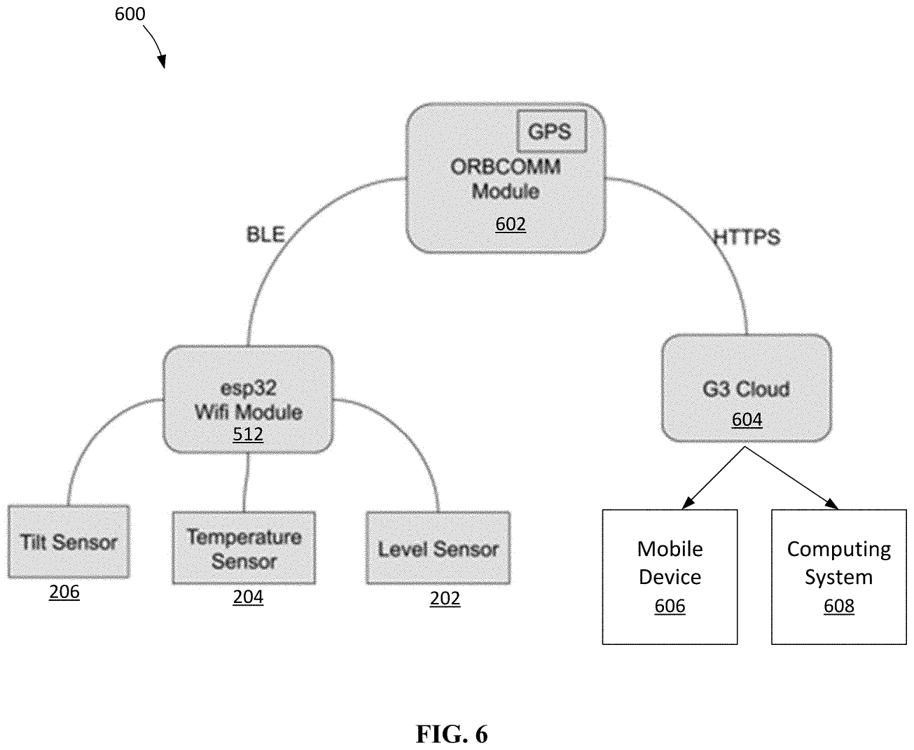

FIG. 6 is a diagram illustrating an example communication scheme 600 for the sensor system 108. The scheme 600 represents the capacity sensor 202, temperature sensor 204, and tilt sensor 206 that collect gondola fill level data, temperature data, and tilt data, respectively. The data can be provided to communication module 512 (e.g., Wi-Fi module and/or Bluetooth module). The communication module 512 can receive data from the sensors 202, 204, and 206. Such data can be received by the communication module 512 continuously, periodically (e.g., each second, minute, or hour), or upon request (e.g., on-demand). In some embodiments, the sensor data from sensors 202, 204, 206 may first be processed before being sent to the communication module 512 or be processed at a processor within the communication module 512. The communication module 512 may consolidate the sensor data into a single data packet (e.g., covering a given time period) and/or may use a separate processor (e.g., processor 211) for this task. The communication module 512 may transmit the data packet to a communication module 602 via a communication protocol, e.g., Bluetooth or Bluetooth LE. For example, the communication module 512 may send sensor data to the communication module 602 in the following string format (e.g., data sent as comma separated values):

{ID,temperature,x-axis acceleration,y-axis acceleration,z-axis acceleration,fill level,firmware version}

where ID is the identification number or name assigned to the particular sensor system 108, temperature is the temperature data (e.g., in Celsius or Fahrenheit), x-axis acceleration is the acceleration data in the x-axis (indicative of tilt), y-axis acceleration is the acceleration data in the y-axis (indicative of tilt), z-axis acceleration is the acceleration data in the z-axis (indicative of tilt), level is the capacity and/or fill level data, and the firmware version is the current version of the firmware for operating the sensor system 108.

The communication module 602 may store the data packets received from module 512. The communication module 602 may include a GPS. The communication module 602 may be or include a GPS tracking device (e.g., made by ORBCOMM of Rochelle Park, N.J., USA) configured to remotely track and monitor certain assets. In some embodiments, the sensor system 108 is integrated with or includes the communication module 602, which may include or be the same as communication module 518. Additionally or alternatively, the communication module 210 in the sensor system 108 can include the communication module 512 and/or the communication module 602.

In some embodiments, the communication module 602 is configured to send the sensor data from the capacity sensor 202 (e.g., capacitive sensor 510), temperature sensor 204 and/or tilt sensor (e.g., accelerometer 516) via an Internet connection (e.g., using a cellular network or a satellite communication) to a cloud network 604 or other computer network (e.g., the Internet), which may be or include remote computing system 212 (e.g., including a server system and one or more user client devices). The communication module 602 may also transmit the GPS data associated with the particular sensor system 108. In some embodiments, the cloud network 604 may retrieve the sensor data and/or GPS data from the communication module 602.

In some embodiments, one or more data of the sensor data and/or GPS data may be sent to and/or retrieved by a mobile device 606 and/or another computing system 608 via the cloud network 604. The mobile device 606 may be a user device, e.g., a smartphone, a smartwatch, a tablet, a laptop computer, a notebook computer, smart glasses, smart headset, etc. In some cases, the mobile device 606 may be part of or in close proximity to the sensor system 108, trailer 104, or truck 106. For example, a field worker or equipment loader operator who needs to know when gondola 102 is full (e.g., to stop filling the particular gondola or to fill the next gondola in the prescribed sequence) can access the data via a personal smartphone or a console system on truck 106. In another example, the sensor system 108 may display the data in user interface 214 for field workers who are physically present with the gondolas 102. In another example, the computing system 608 may be remote from the field where the gondolas 102 are utilized. This computing system 608 may use the sensor data to monitor the locations and/or movements of the gondolas 102 over one or more fields and/or to or from produce processing facilities. Advantageously, the computing system 608 can be used to manage gondola usage and locations, to ensure gondolas are being properly utilized and filled, and that produce is being handled properly and remains fresh while being stored and/or transported. In some embodiments, the computing system 608 may generate and push notifications or alerts related to the gondola or produce conditions (e.g., fill level, temperature, tilt, trailer location, etc.) to the mobile device 606.

In various instances, communications between system components may be limited or unable to take place when the sensor system 108 is located in a remote area, such as a remote agricultural field, where a connection to a cellular network, mobile network, or other network is limited or unavailable. For example, with no network connection, the communication module 602 may be unable to exchange data with the cloud network 604, or the cloud network 604 may be unable to exchange data with the mobile device 606 or computing system 608. In such instances, data can be stored until a suitable network connection is available and the data can be sent or retrieved. For example, the communication module 512 or a related storage device can store data when no network connection is available and then send the data to the cloud network 604 later, once a network connection has been established.

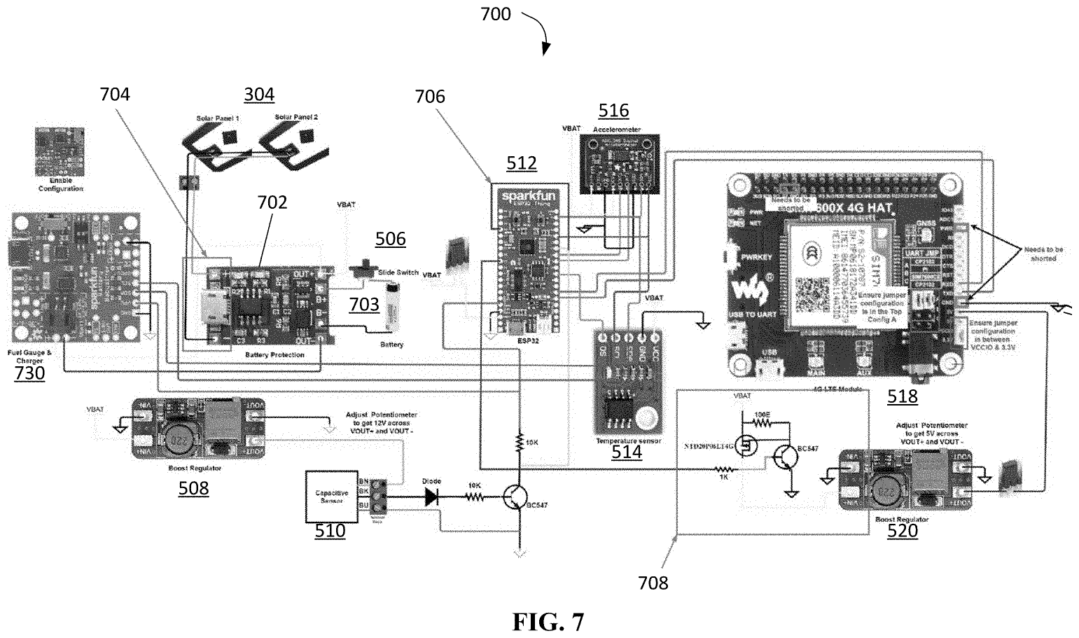

FIG. 7 includes a schematic diagram 700 of a sensor system (e.g., the sensor system 108), according to some embodiments. As shown, like reference numbers used for features described above (e.g., for FIGS. 5A and 5B) are used to represent the same or similar features shown in FIG. 7. For example, the one or more solar panels 304 shown in FIG. 7 can be the same as the one or more solar panels 304 shown in FIG. 5A.

Compared to the embodiment shown in FIGS. 5A and 5B, the embodiment shown in FIG. 7 includes a revised battery charger 702 for charging and monitoring a battery 703. The battery charger 702 can include or utilize a babysitter circuit 730 to protect and/or monitor the battery 703 and/or the battery charger 702. The battery charger 702, in some implementations, can include a connection 704 to one or more solar panels 304, which can charge the battery 703. The battery charger 702 and/or battery 703 can be configured to provide power to one or more other components of the sensor system. Additionally or alternatively, in some examples, two or more pins 706 (e.g., pins 39 and 23) of the communication module 512 can be connected to one another to enable power consumption monitoring for the boost regulator 520. In some instances, the boost regulator 520 can be configured to supply regulated power to the communication module 518. In some implementations, the sensor system can include a field effect transistor (FET) circuit 708, which can be configured to trigger an on and/or off status from the capacitive sensor 510 to the communication module 512. Additionally or alternatively, the FET circuit 708 can be configured to regulate power (e.g., via the boost regulator 520), for example, to turn the communication module 518 on and/or off.

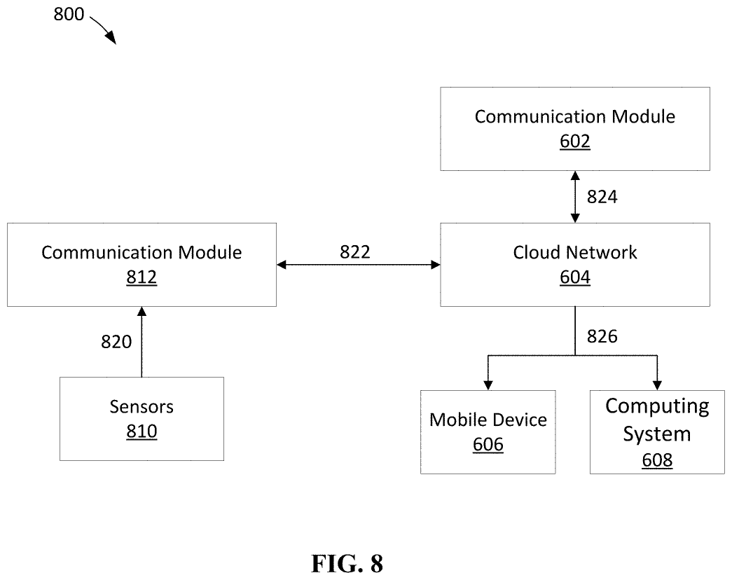

FIGS. 8-11 illustrate example communication schemes for a sensor system (e.g., the sensor system 108), according to some embodiments. Like reference numbers pointing to features described above (e.g., for FIG. 6) are used to represent the same or similar features described in FIGS. 8-11. For example, the cloud network 604 shown in FIGS. 8-11 can be the same as the cloud network 604 shown in FIG. 6.

FIG. 8 is a schematic diagram of an example communication scheme 800 for a sensor system (e.g., the sensor system 108), according to some embodiments. The communication scheme 800 can utilize or include one or more sensors 810 that collect data for a gondola, such as, for example, a capacity sensor (e.g., the capacity sensor 202), a temperature sensor (e.g., the temperature sensor 204), a tilt sensor (e.g., the tilt sensor 206), one or more other sensors, or any combination thereof. The collected data can be or include, for example, fill level data, temperature data, and/or tilt data, among other types of data. The collected data (e.g., signals or values from the one or more sensors 810) can be communicated and/or provided to a communication module 812, such that the communication module 812 can receive the data (e.g., in a one-way or two-way communication) from the one or more sensors 810. The data can be transmitted from the sensors 810 to the communication module 812 via a hard-wired or a wireless communication path 820.

In various examples, the communication module 812 can include one or more communication devices, which can send and/or receive data. For example, the communication module 812 can include a Wi-Fi module, a BLUETOOTH module, a ZIGBEE module, a broadband cellular network module (e.g., a 4G network module, a 5G network module, etc.), other communication devices (e.g., wireless communication devices), or any combination thereof. In one example, data can be sent from one communication device (e.g., a WiFi module) to another communication device (e.g., a 4G module) in the communication module 812.

In some embodiments, the communication module 812 can exchange data with the cloud network 604 along a wireless communication path 822, which can enable one-way or two-way communications. The wireless communication path 822 can utilize a variety of data transmission techniques, including, for example, 4G LTE, 5G LTE, or other cellular data standards. In some examples, the communication module 812 can be or include the communication module 512, described above.

Still referring to FIG. 8, the communication scheme 800 can include the communication module 602, described above, which can include a GPS device (e.g., a GPS tracking device) and a display or user-interface. The communication module 602 can be connected to the cloud network 604 via a communication path 824, which can be wired or wireless and/or can enable one-way or two-way communication. The communication path 824 can enable data to be exchanged between the communication module 602 and various system components. In some instances, for example, the communication module 602 can receive data from other system components and can process and/or display the data. For example, data from the one or more sensors 810 can be sent to the communication module 602, which can display the data (e.g., on a dashboard) or otherwise provide users with access to the data. The communication path 824 can utilize an application programming interface (API) that enables software components on the communication module 602 to exchange data with other software components in the system (e.g., the cloud network 604).

Additionally or alternatively, in various examples, data collected by the communication module 602 (e.g., GPS data) can be sent from the communication module 602 to other system components, where the data can be processed and/or displayed. For example, GPS data from the communication module 604 and/or data from the communication module 812 (e.g., including data collected by the sensors 810) can be sent via the cloud network 604 to the mobile device 606 and/or the computing system 608, described herein. The mobile device 606 and/or the computing system 608 can be user client devices and/or can include a display, a dashboard, and/or a user interface for presenting the data to users and/or receiving user input. Data transmissions between the cloud network 604 and the mobile device 606 and the computing system 608 can utilize a communication path 826, which can enable one-way or two-way communications.

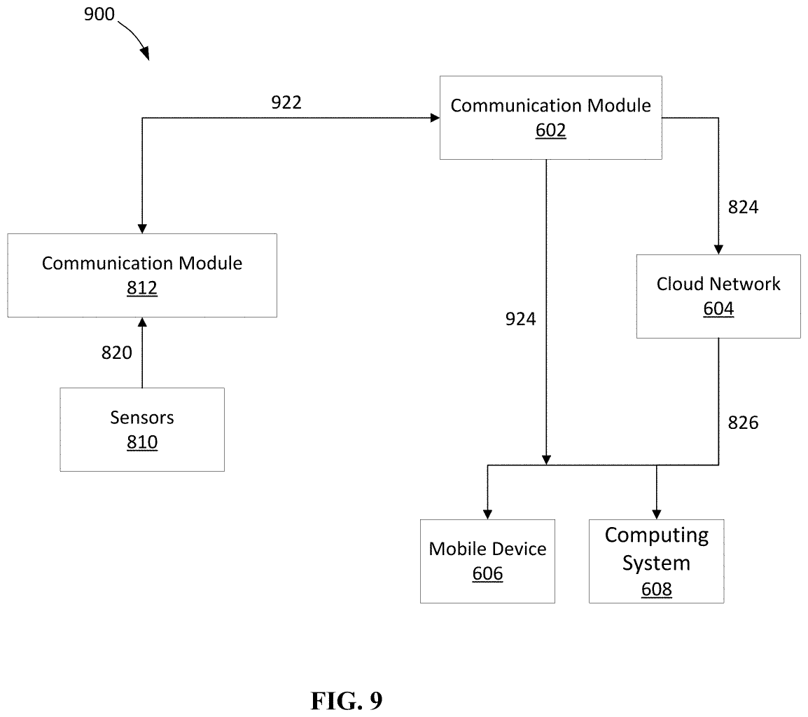

FIG. 9 is a schematic diagram illustrating an example communication scheme 900 for a sensor system (e.g., the sensor system 108), according to some embodiments. Compared to the scheme 800, the scheme 900 can include a direct, wired connection 922 between the communication module 602 and the communication module 812. The wired connection 922 can avoid use of cellular communications, the cloud network 604, and/or the Internet for exchanging data between the communication module 602 and the communication module 812. For example, data collected by the sensors 810 can be sent from the communication module 812 to the communication module 602 (e.g., for display on a dashboard) using the wired connection 922. In general, the wired connection can be suitable when the communication modules 602 and 812 are in close proximity to one another. Further, compared to the scheme 800, in addition to or instead of using the communication paths 824 and 826, the scheme 900 can utilize a communication path 924 for sending data from the communication module 812 to the mobile device 606 and/or the computing system 608. The communication path 924 can be used to send data without using the cloud network 604.

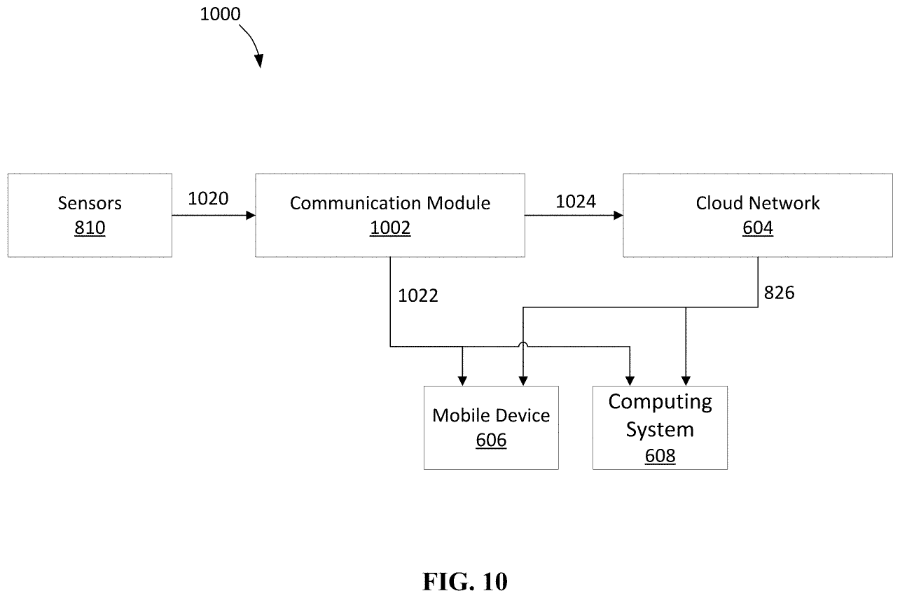

FIG. 10 is a schematic diagram illustrating an example communication scheme 1000 for a sensor system (e.g., the sensor system 108), according to some embodiments. This example utilizes a communication module 1002 that receives signals or data from the one or more sensors 810 via a connection path 1020, which can be wired or wireless and/or can enable one-way or two-way communication. Additionally or alternatively, one or more sensors (e.g., a GPS tracking device and/or a thermometer) can be incorporated into the communication module 1002. Data received from the one or more sensors 810 and/or sensors in the communication module 1002 can be processed by the communication module 1002 and/or displayed on a dashboard or user-interface associated with the communication module 1002. The communication module 1002 can incorporate some or all of the components and/or functionality described herein for communication modules 602 and/or 812, described herein. For example, the communication module 1002 can be the same as or substantially similar to the communication module 602. In various examples, the communication module 1002 can send data along a communication path 1022 to the mobile device 606 and/or the computing system 608. Additionally or alternatively, the communication module 1002 can send data along a communication path 1024 to the cloud network 604. The communication path 1022 and/or the communication path 1024 can be wired or wireless and/or can enable one-way or two-way communication. In some examples, the communication path 1024 can utilize an API connection. The cloud network 604 can send data (e.g., generated using the one or more sensors 810 and/or one or more sensors in the communication module 1002) along the communication path 826 to the mobile device 606 and/or the computing system 608.

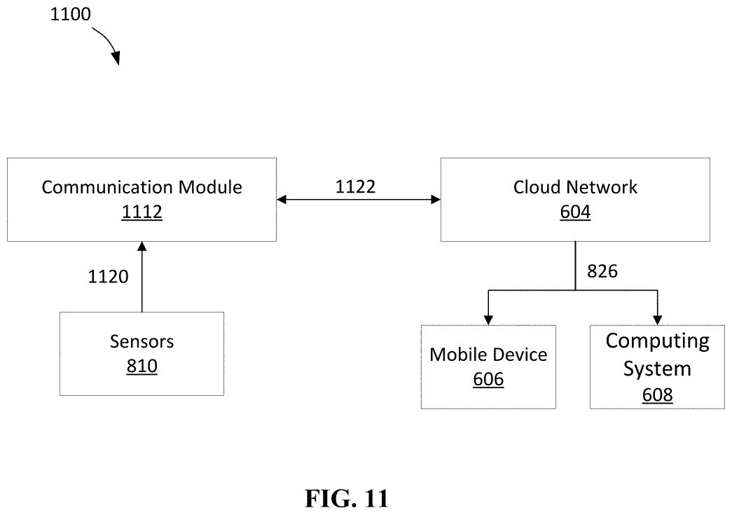

FIG. 11 is a schematic diagram illustrating an example communication scheme 1100 for a sensor system (e.g., the sensor system 108), according to some embodiments. This example utilizes a communication module 1112 that receives signals or data from the one or more sensors 810 via a connection path 1120, which can be wired or wireless and/or can enable one-way or two-way communication. Additionally or alternatively, one or more sensors (e.g., a GPS tracking device and/or a thermometer) can be incorporated into the communication module 1112. In some instances, for example, the communication module 1112 can include or utilize a cellular module (e.g., 4G module) to obtain GPS data. Data received from the one or more sensors 810 and/or sensors in the communication module 1112 can be processed by the communication module 1112 and/or displayed on a dashboard or user-interface associated with the communication module 1112. The communication module 1112 can incorporate some or all of the components and/or functionality described herein for communication modules 602 and/or 812, described herein. For example, the communication module 1112 can be the same as or substantially similar to communication modules 512 and 812, described herein. In various examples, the communication module 1112 can send data along a communication path 1122 to the cloud network 604. The communication path 1122 can be wired or wireless (e.g., using a cellular network to transmit 4G LTE data) and/or can enable one-way or two-way communication. The cloud network 604 can send data (e.g., generated using the one or more sensors 810 and/or one or more sensors in the communication module 1112) along the communication path 826 to the mobile device 606 and/or the computing system 608.

Some of the communication schemes presented herein (e.g., schemes 600, 800, and 900) are described as including two separate communication modules (e.g., modules 512 and 602 in scheme 600). In various examples, the two separate communication modules may be referred to herein collectively as a single communication module (e.g., “the communication module”). It is understood that such references to a single communication module can cover embodiments in which more than one communication module is used.

### Hardware and Software Implementations

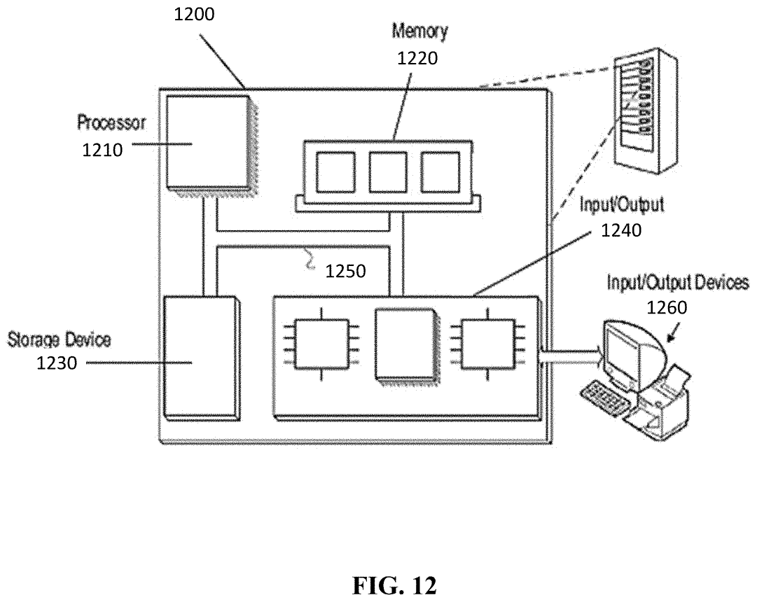

FIG. 12 is a block diagram of an example computer system 1200 that may be used in implementing the technology described in this document. General-purpose computers, network appliances, mobile devices, or other electronic systems may also include at least portions of the system 1200. The system 1200 includes a processor 1210, a memory 1220, a storage device 1230, and an input/output device 1240. Each of the components 1210, 1220, 1230, and 1240 may be interconnected, for example, using a system bus 1250. The processor 1210 is capable of processing instructions for execution within the system 1200. In some implementations, the processor 1210 is a single-threaded processor. In some implementations, the processor 1210 is a multi-threaded processor. The processor 1210 is capable of processing instructions stored in the memory 1220 or on the storage device 1230.

The memory 1220 stores information within the system 1200. In some implementations, the memory 1220 is a non-transitory computer-readable medium. In some implementations, the memory 1220 is a volatile memory unit. In some implementations, the memory 1220 is a non-volatile memory unit.

The storage device 1230 is capable of providing mass storage for the system 1200. In some implementations, the storage device 1230 is a non-transitory computer-readable medium. In various different implementations, the storage device 1230 may include, for example, a hard disk device, an optical disk device, a solid-date drive, a flash drive, or some other large capacity storage device. For example, the storage device may store long-term data (e.g., database data, file system data, etc.). The input/output device 1240 provides input/output operations for the system 1200. In some implementations, the input/output device 1240 may include one or more of a network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 1260. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 1230 may be implemented in a distributed way over a network, for example as a server farm or a set of widely distributed servers, or may be implemented in a single computing device.

Although an example processing system has been described in FIG. 12, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A sensor system for monitoring conditions of a gondola configured to hold harvested produce and be transported by a trailer, the sensor system comprising:
a capacity sensor configured to determine a remaining capacity of the gondola;
a temperature sensor configured to monitor at least one of a temperature of the gondola, a temperature of an environment around the gondola, or a temperature of the harvested produce held by the gondola;
a trailer location sensor configured to determine a global position of the gondola; and
a communication module in communication with the capacity sensor, the temperature sensor, and the trailer location sensor and configured to transmit data from the capacity sensor, the temperature sensor, and the trailer location sensor to a remote computing system.

2. The sensor system of claim 1, wherein the communication module comprises:
a first communication module in communication with the capacity sensor and the temperature sensor; and
a second communication module in communication with the trailer location sensor.

3. The sensor system of claim 2, wherein the first communication module transmits data from the capacity sensor and the temperature sensor to the second communication module, and wherein the second communication module transmits the data from the capacity sensor, the temperature sensor, and the trailer location sensor to the remote computing system.

4. The sensor system of claim 3, wherein the first communication module and the second communication module are configured to communicate via a wireless connection.

5. The sensor system of claim 3, wherein the first communication module and the second communication module are configured to communicate via a wired connection.

6. The sensor system of claim 2, wherein the first communication module transmits the data from the capacity sensor and the temperature sensor to the remote computing system, and wherein the second communication module transmits the data from the trailer location sensor to the remote computing system.

7. The sensor system of claim 2, wherein the second communication module is configured to:
retrieve from the remote computing system the data from the capacity sensor and the temperature sensor; and
display the data from the capacity sensor, the temperature sensor, and the trailer location sensor.

8. The sensor system of claim 1, wherein the communication module comprises the trailer location sensor, and wherein the communication module receives the data from the capacity sensor and the data from the temperature sensor via wired communication.

9. The sensor system of claim 8, wherein the communication module is configured to display the data from the capacity sensor, the temperature sensor, and the trailer location sensor.

10. The sensor system of claim 1, wherein the remote computing system comprises at least one of a cloud network or a client device of a user.

11. The sensor system of claim 1, further comprising a tilt sensor configured to monitor a tilt of the gondola.

12. A method for monitoring a gondola configured to hold harvested produce and be transported by a trailer, the method comprising:
obtaining, via a capacity sensor, capacity data indicating a remaining capacity of the gondola;
obtaining, via a temperature sensor, temperature data indicating at least one of a temperature of the gondola, a temperature of an environment around the gondola, or a temperature of the harvested produce held by the gondola;
obtaining, via a trailer location sensor, trailer location data indicating a global position of the gondola; and
transmitting, via a communication module, the capacity data, the temperature data, and the trailer location data to a remote computing system, wherein the communication module is in communication with the capacity sensor, the temperature sensor, and the trailer location sensor.

13. The method of claim 12, wherein the communication module comprises:
a first communication module in communication with the capacity sensor and the temperature sensor; and
a second communication module in communication with the trailer location sensor.

14. The method of claim 13, wherein transmitting the capacity data, the temperature data, and the trailer location data to a remote computing system comprises:
transmitting the capacity data and the temperature data from the first communication module to the second communication module; and
transmitting the capacity data, the temperature data, and the trailer location data from the second communication module to the remote computing system.

15. The method of claim 13, wherein the first communication module and the second communication module are configured to communicate via a wireless connection.

16. The method of claim 13, wherein the first communication module and the second communication module are configured to communicate via a wired connection.

17. The method of claim 13, wherein transmitting the capacity data, the temperature data, and the trailer location data to a remote computing system comprises:
transmitting the capacity data and the temperature data from the first communication module to the remote computing system; and
transmitting the trailer location data from the second communication module to the remote computing system.

18. The method of claim 13, further comprising:
retrieving, via the second communication module, the capacity data and the temperature data from the remote computing system; and
displaying, via the second communication module, the capacity data, the temperature data, and the trailer location data.

19. The method of claim 12, further comprising:
receiving, via the communication module over wired communication, the capacity data and the temperature data, wherein the communication module comprises the trailer location sensor.

20. The method of claim 19, further comprising:
displaying, via the communication module, the capacity data, the temperature data, and the trailer location data.

21. The method of claim 12, wherein the remote computing system comprises at least one of a cloud network or a client device of a user.

22. The method of claim 12, further comprising:
obtaining, via a tilt sensor, tilt data indicating a tilt of the gondola; and
transmitting, via the communication module, the tilt data to the remote computing system, wherein the communication module is in communication with the tilt sensor.
